(19) United States
(12) Patent Application Publication
(10) Pub. No.: US 2008/0050489 A1
(43) Pub. Date: Feb. 28, 2008

(54) Method for extracting a cereal constituent

(75) Inventor: Lov Jeff, Tesjoki (FI)

Correspondence Address: CONNOLLY BOVE LODGE & HUTZ LLP, 1875 EYE STREET, N.W., SUITE 1100, WASHINGTON, DC, 20036, US

(73) Assignee: Oy Glubikan Ab, Tesjoki (FI)

(21) Appl. No.: 11/629,191

(22) PCT Filed: Jun. 10, 2005
(86) PCT No.: PCT/FI05/50207

§ 371 Date: Dec. 11, 2006

(30) Foreign Application Priority Data
Jun. 11, 2004 (FI) 20040804

(51) Int. Cl. A23B 4/03

(52) U.S. Cl. 426/456

(57) ABSTRACT

The invention relates to a method for extracting β-glucan from cereals. The extraction is carried out using wetted cereals by adjusting the pH thereof to a value below 5.2 with an acid, and further, by treating the cereal in an enclosed space under pressure less than about 5 bar, at a temperature of 100-130° C. After the treatment, the liquid phase is separated from the solid material, followed by recovery of β-glucan from this separated aqueous phase.

The present invention relates to a method for extracting a constituent present in a cereal grain. The target of the extractive operation is the carbohydrate β-glucan of the cereal. The proportion of this fraction varies among different cereal species, being particularly high in oats. It has been found that favourable effects e.g. on metabolism may be evoked by high β-glucan contents in human nutrition, and therefore, attempts have been made to extract this compound considered as a so-called soluble fiber from edible products to be added to products, in which this compound is not naturally present, or in which it is desirable to increase the inherent contents thereof.

To extract said fraction from a suitable cereal variety, for instance repeated dry milling and screening steps to obtain cereal fractions having significantly higher β-glucan contents in comparison to the starting material are suggested. Such a process is presented in WO 01/26479. It is reported that fractions containing more that 10% of glucan are obtained with the process in industrial scale.

Also wet processes to extract β-glucan from cereals are known. These processes are normally based on extraction with an alkaline agent followed by various purification and separation steps. Downstream processing comprise treatments with organic solvents causing well known problems in process conditions. Organic solvents have also been used to remove fatty fractions from cereals prior to dry milling, thus avoiding the interference of fat in the operation of the milling and screening equipments. Also in this case, organic solvents cause similar problems as in said extraction methods.

The object of the present invention is to provide a method for treating cereals to obtain β-glucan contained therein as an enriched fraction with high yields.

The method of the invention is basically a so-called wet process. The starting material is wetted with water prior to treatment steps. In various embodiments of the invention, either ground cereal, or substantially whole grains are used as the starting material. For this reason, the process steps to be carried out are slightly different from each other. In this specification, wetting means the addition of an amount of water to the starting material to be treated for adjusting the dry matter content thereof between 7 and 10%. In case ground cereal is used, the mixture of flour and water may be subjected to the treatment almost immediately. On the contrary, whole grains must first be steeped in water for a suitable period of time for the absorption of a necessary amount of water. According to a special feature of the invention, the pH of the water to be added to flour, or to be absorbed by grains is adjusted to be in the treatment step less than 5.2, preferably less than 4.7. According to the desired result, the chain length of β-glucan sought, the pH may be less than 4.2, even less than 3.6.

The next step in the treatment comprises a heat treatment under pressure. This step is carried out at temperatures between 100 and 130° C. The pressure is adjusted up to 5 bar, preferably between 3 and 4 bar, the pressure being either that of the saturated water vapour corresponding to the temperature used, or alternatively a pressure obtained by applying external forces to the material being treated, thus elevating the pressure to higher values than those provided by saturated water vapour at respective temperatures.

To elevate the temperature, different heating procedures may be used, either indirect heating or direct heating. Indirect heating is more preferable since local overheating of the material being treated may thus be prevented more easily. Extreme temperatures should be avoided since they may cause reactions breaking down carbohydrates of the material being treated. However, it is also possible to use controlled heating by directly passing evenly distributed steam to the material being treated, particularly in embodiments of the method using treatment pressures corresponding to that of saturated vapour depending on the temperature.

External pressures may be applied in different ways to the material being treated. A suitable procedure is to carry out the treatment continuously forcing the material to pass through a treatment vessel, the outlet of which is throttled to maintain a suitable pressure. The pressure may be provided by a suitable feeding pump. The feeding device may also extend through the whole treatment vessel, for instance in form of a screw conveyor.

Under these conditions, the treatment is carried out as so-called vapour phase cooking. The time of the heat treatment primarily depends on the treatment temperature used, being of the order from 10 to 20 minutes, normally about 15 minutes.

With respect to pressures used, it was found that variation thereof during the heat treatment has a favourable influence on the β-glucan yield. Once the material being treated has been under a desired treatment pressure for a period of time, the material is subjected to pressure variation or to several pressure variations. The pressure applied to the material being treated may be temporarily reduced, and then elevated again to the desired treatment value. This procedure may be repeated several times during the treatment. The procedure may be used both for processes operated batch-wise and for continuous processes. For continuous processes, the reduction of the pressure may conveniently be carried out in connection with the cycles for removing the treated product from the process, thus the temporary pressure reduction being caused by this removal.

Another alternative to provide a pressure variation is to apply an momentary elevated pressure to the material, followed by pressure recovery to the desired treatment value. This pressure impact may for instance be provided with a compressive force applied to the material. This may conveniently be the consequence of the transport of the material in a continuous process wherein a intermittently operating feeding device causes the desired impulse directed to the material.

In practice, the pressure varies at least by 0.5 bar below or above the desired treatment pressures. Also larger pressure variations, particularly instantaneous pressure reductions are useful, and thus, the pressure may even be lowered to almost ambient pressure values for a short period of time. As a practical limit for the pressure reduction, a value half of that of the desired treatment pressure may be set, since after this pressure reduction, it is necessary to subject the material again to desired treatment pressures.

Pressure variations during the treatment are favourable to the β-glucan yield by causing a kind of a “pumping effect” for separating β-glucan.

Pressure reduction, or pressure elevation, as the case may be, to reach the desired treatment pressure is carried out several times, or at least once during the process. The procedure may, however, be repeated several times, up to 5 or 6 times during the process, or even more often, especially when using pressure impulses. It was found that the height of the pressure difference and the number of the pressure variations during the process had an effect on the β-glucan yield.

It was found that β-glucan obtained with the method had a maximum molecular length when the treatment temperature used in the process was from 128 to 130° C., the treatment pH varying between 4.1 and 4.3. Particularly, the pH value used in the process had an influence on the molecular length of the β-glucan obtained.

With the process of the invention, β-glucan yields being at the same level as the amounts that may be analyzed from the starting material are obtained, these yields even suggesting that the assays of the starting material possibly comprise operations that are harmful to the product being analyzed.

In the method of the invention, particularly in case of whole grains, an impact procedure may be used to effectively break down the grain structure following the heat treatment. In this procedure, the pressurized grain material is instantaneously subjected to substantially ambient pressures, thus breaking down the grain structure due to sudden reduction of the internal grain pressure.

After the heat treatment, the aqueous fraction enriched with β-glucan is separated from the mass obtained. Using proper post treatments, the β-glucan contents may be elevated to a level of 47%.

Following the heat treatment, the aqueous fraction is separated from the mass obtained by centrifugation, but also other known separation methods such as different kinds of pressing devices may be used. The aqueous fraction separated from the solid material may be concentrated by post treatments, including not only conventional evaporation but also for instance ultrafiltration. Also combinations of these treatments may be used. The solid material obtained after the separation of the aqueous fraction, the mash, may be used for instance as feed.

The acid to be used upsteam of the process for acidification is of course a food quality acid, preferably an organic acid such as citric acid or lactic acid.

1. Method for extracting β-glucan from cereals, the extraction being carried out using wetted cereals, characterized in that the pH of the cereal is adjusted to a value below 5.2 with an acid, and further, the cereal is treated in an enclosed space under pressure less than about 5 bar, at a temperature of 100-130° C., the liquid phase is separated from the solid material following depressurization, followed by recovery of β-glucan from this separated aqueous phase.

2. Method of claim 1, characterized in that the pH of the wetted cereal is adjusted to a value from 4.7 to 3.6.

3. Method of claim 2, characterized in that the pH of the wetted cereal is adjusted to a value of 4.2.

4. Method of claim 2, characterized in that the pH of the wetted cereal is adjusted to a value of 3.6.

5. Method according to claim 1, characterized in that the treatment is carried out at a pressure from 3 to 4 bar.

6. Method according to claim 1, characterized in that the material is subjected to at least one pressure variation during the treatment.

7. Method of claim 6, characterized in that the pressure variation ranges between the desired treatment pressure ±0.5 bar.

8. Method of claim 6, characterized in that the pressure variation is provided by a momentary pressure reduction with respect to the desired treatment pressure.

9. Method of claim 6, characterized in that the pressure variation is provided by a momentary pressure impulse higher than the desired treatment pressure.

10. Method of claim 6, characterized in that the pressure is momentarily lowered to substantially ambient pressure.

11. Method according to claim 1, characterized in that the dry matter content of the cereal subjected to the heat treatment is adjusted to a value between 7 and 10%.

12. Method according to claim 1, characterized in that the cereal is ground prior to wetting.

13. Method according to claim 1, the cereal being used as whole grains, characterized in that the cereal is steeped in acidified water to a desired moisture content, the heat treatment is carried out at this desired moisture content, and the heat treatment is terminated by sudden pressure reduction.

14. Method according to claim 1, characterized in that the treatment pressure is elevated to a value higher than that of the respective saturated vapour pressure at the treatment temperature by an external pressure force.

15. Method according to claim 9, characterized in that the treatment pressure is elevated by compressive force applied to the material being treated.

16. Method according to claim 2, characterized in that the treatment is carried out at a pressure from 3 to 4 bar.

17. Method according to claim 3, characterized in that the treatment is carried out at a pressure from 3 to 4 bar.

18. Method according to claim 4, characterized in that the treatment is carried out at a pressure from 3 to 4 bar.

19. Method according to claim 2, characterized in that the material is subjected to at least one pressure variation during the treatment.

20. Method according to claim 3, characterized in that the material is subjected to at least one pressure variation during the treatment.
